(19) United States
(12) Patent Application Publication
(10) Pub. No.: US 2013/0238157 A1
(43) Pub. Date: Sep. 12, 2013

(54) ENERGY MANAGEMENT SYSTEM

(71) Applicants: Jonathan Luke, St. Asaph Denbighshire (GB); Stavros Antoniou, St. Asaph Denbighshire (GB); Yann Bussard-Mogrovejo, Worcester Worcestershire (GB); David Hall, St. Asaph Denbighshire (GB); Andrew Katsouris, St. Asaph Denbighshire (GB)

(72) Inventors: Jonathan Luke, St. Asaph Denbighshire (GB); Stavros Antoniou, St. Asaph Denbighshire (GB); Yann Bussard-Mogrovejo, Worcester Worcestershire (GB); David Hall, St. Asaph Denbighshire (GB); Andrew Katsouris, St. Asaph Denbighshire (GB)

(73) Assignee: SENSELOGIX LIMITED, Greater Manchester (GB)

(21) Appl. No.: 13/642,216

(22) PCT Filed: Apr. 15, 2011
(86) PCT No.: PCT/EP11/56061

§ 371 Date: May 29, 2013

(30) Foreign Application Priority Data
Apr. 20, 2010 (GB) 1006510.0

(51) Int. Cl. G06F 1/32

(52) U.S. Cl. CPC G06F 1/3296
USPC 700/295

(57) ABSTRACT

An energy management system (1) comprising: policy establishment means (3) for establishing one or more energy policies, the or each said policy being configured for managing the energy consumption of at least one energy consuming appliance (7); and at least one energy node (5) configured to communicate with said energy policy establishing means (3) to implement an energy policy for the control of at least one energy consuming appliance (7) with which said energy node (5) is configured to communicate.

### FIELD

This invention relates to energy management systems, particularly but not exclusively to systems for the management of electrical energy consumption. In one envisaged implementation the invention relates to a distributed management system with a plurality of controllable energy nodes.

### BACKGROUND

As energy consumption, and the resultant effect on emissions, becomes more of a environmental concern, it is becoming more common for individuals, companies and other organisations to seek to reduce their consumption of energy, particularly but not exclusively electrical energy consumption. These concerns, coupled with recent increases in energy costs, Government efforts to encourage energy frugality, and a growing public appreciation of the finite nature of fossil fuel resources have all helped raise public acceptance of the need for managing energy consumption.

In the commercial environment, it has become more commonplace for companies and other organisations to adopt a formal environmental policy, and such policies typically exhort members of those companies and organisations to find ways to reduce energy consumption.

One illustrative way of achieving this is to post notices around a company or other organisation which remind staff to conserve energy, for example by switching off lights and other electrical devices when not in use. Another more extreme way of managing consumption is to periodically power down the organisation or company for predetermined periods of time.

The first approach only tends to work well if staff share the environmental concerns of the organisation that is seeking to conserve energy and consistently remember to conserve energy. Unfortunately, however it is often the case that many staff fail to see energy conservation as a being a benefit to them, and as such this approach can often be not particularly effective. The other aforementioned approach to energy conservation can be very effective in reducing power consumption, but it requires careful on-site management and can cause problems if staff are working unusual hours.

Aspects of the present invention seek to address these and other problems.

### SUMMARY

To this end, a first aspect of the teachings of the invention provides an energy management system that comprises: means for establishing one or more energy policies, each said policy being configured for managing the energy consumption of at least one energy consuming appliance; at least one energy node configured to communicate with said energy policy establishing means to implement an energy policy for the control of at least one energy consuming appliance with which said energy node is configured to communicate.

Other features, advantages and implementations of the teachings of the invention will be apparent from the following detailed description.

### BRIEF DESCRIPTION OF THE DRAWINGS

Various aspects of the teachings of the present invention, and arrangements embodying those teachings, will hereafter be described by way of illustrative example with reference to the accompanying drawings, in which:

FIG. 1 is a schematic representation of an illustrative energy management system;

FIG. 2 is a schematic representation of an envisaged implementation of an energy management system;

FIG. 3 is a schematic representation of another envisaged implementation of an energy management system;

FIG. 4 is a schematic representation of an illustrative energy node;

FIG. 5 is a schematic representation of another envisaged implementation of the energy management system in FIG. 2; and

FIG. 6 is a schematic representation of another envisaged implementation of the energy management system in FIG. 3.

### DETAILED DESCRIPTION

Illustrative energy management systems will now be described with particular reference to systems for the management of electrical energy consumption. It will be appreciated, however, that this particular application of the teachings of the invention is merely illustrative and that the systems described herein may be employed for consumption management of other forms of energy. As such, the following detailed description should not be construed as being a limitation of the teachings of this invention, but instead as being merely illustrative of one particular application of those teachings.

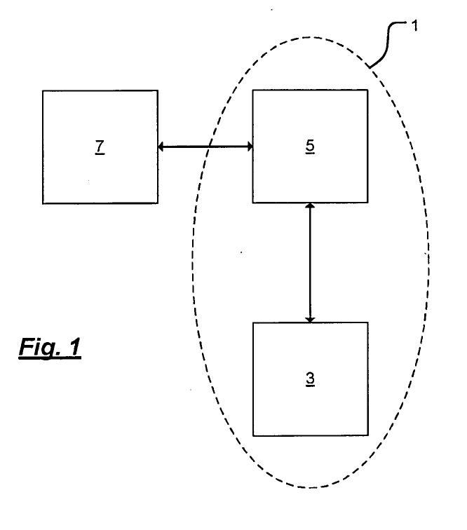

With the above proviso in mind, reference will now be made to FIG. 1 of the accompanying drawings in which there is depicted an illustrative energy management system 1 accordingly to an envisaged implementation of the teachings of the invention.

The system 1 comprises means 3 for establishing one or more energy policies, and at least one energy node 5. For simplicity this illustrative example includes a single energy node, but it will be appreciated that a typical installation will include a plurality of such nodes.

As shown in FIG. 1 the policy establishing means 3 is configured to communicate with the energy node 5, in particular to enable a user to cause the node to be provided with a desired energy policy. The energy node 5 is configured to communicate and optionally control an energy consuming appliance 7.

The energy policy established by the policy establishing means may comprise, for example, user instructions as to when the energy consuming appliance is to be powered up, and when the appliance is to be powered down.

In one envisaged implementation the policy establishing means 3 may comprise a computing resource, such as a desktop or laptop computer, that is enabled to communicate with the energy node via an internet interface to establish a policy for an appliance.

The energy node 5 may have a number of different forms depending on the appliance to be controlled. In one illustrative implementation the energy node 5 comprises a computing resource that is configured to control an electrical supply to an appliance in accordance with an established energy policy. The energy node may communicate with the appliance via a wired connection (such as an Ethernet LAN connection) or a wireless connection (such as a Wi-Fi connection). The energy node 5 may also be configured to monitor operation of the appliance, and optionally obtain measurements of energy consumption for local processing by the energy node 5, or remote processing (for example at the energy policy establishing means 3).

FIG. 2 is a schematic representation of an envisaged implementation of an illustrative energy management system. In this illustrative implementation the system is configured for managing electrical energy consumption, for example of computing resources, and comprises a plurality of distributed energy nodes 9 (one of which is shown) that are coupled to an energy automation appliance 11 which forms, with an energy automation service 13, the aforementioned energy policy establishing means 3.

In this illustrative arrangement, the energy node 9 comprises a small item of hardware which is designed to fit within the cable management infrastructure of a building (such as perimeter cable trunking, floor boxes, power poles, etc.). An advantage of such an arrangement is that it is then possible to provide an “invisible” system with energy management devices hidden behind power outlets within the building.

The energy automation appliance 11 of this illustrative implementation comprises a computing device (for example a computing device with a standard PC architecture in a server or PC format) that connects to each of the energy nodes, for example by means of a standard Ethernet infrastructure of the building in which the nodes are installed.

The energy automation appliance 11 comprises software and hardware that functions to collect and store energy usage data from each of the nodes and to execute “energy policy orchestration” software which sends control messages to the nodes—allowing them to be turned on or off in line with a user defined energy policy.

The system also comprises an energy automation service 13 that comprises, in this particular implementation; a web based service that allows a building owner access to their “energy management” system from outside the building so that they can set and change energy policies from a remote location. The energy automation service may also provide other tools such as reporting, billing, etc.

In addition to the aforementioned core components, the system of this implementation further comprises shutdown software modules 15; each executable by a computing resource 17 that is being managed. The shutdown modules each comprise a software application that is operable to turn off a computing resource at a predetermined time.

The system also comprises status software modules 19, each executable by a computing resource that is being managed. The status modules 19 each comprise a software module that is configured to communicate the current energy status of the computing resource with which it is associated to the energy automation appliance 11, which appliance is configured to ensure that power to that computing resource is not turned off while the resource is still in use. The current energy status of the computing resource is indicative of whether or not the computing resource is in use. When the computing resource is not in use it may occupy a reduced energy state such as: i) a screen saver mode; ii) a hibernation mode; iii) a sleep mode; or iv) a shut down mode.

The system of this implementation also comprises a policy override device 21 which comprises an input device such as a push-button located in the vicinity of a group of computing resources and other appliances that are being managed by the system. The policy override device 21 communicates with the energy automation appliance 11 and allows an energy management policy to be easily overridden—for example if an employee returns to an office out of hours.

Working together, these elements enable the provision of a fully automated energy management system that can be configured to automatically adapt to how a building is being used by its inhabitants—thereby enabling continuous optimisation and reduction of the operational energy consumption of the building as a whole.

Further details of these elements are provided in the headed sections below.

Energy Node

As aforementioned, in an envisaged implementation the energy node is a small hardware device which fits behind the power sockets of the building. In one envisaged implementation the energy node comprises:
An energy meter (for measuring the energy consumed by (in this instance) a computing resource with which the energy node is associated);
A power control component—which enables a connected appliance to be turned on or off. This component could comprise a relay or a solid-state switch such as a TRIAC or a combination of the two—where the TRIAC is used to switch the current (handling any inrush currents) while the more efficient RELAY carries the current shortly after the switching event. Other suitable devices will immediately be apparent to persons of ordinary skill in the art.
A main processor which is configured to measure and calculate analogue variables such as voltage, current, energy consumption, etc of the connected appliance(s) and communicate measurements and calculations to the energy automation appliance for processing and storage. In one envisaged implementation the main processor runs an embedded operating system, application and web server and is responsible for all of the complex tasks carried out within the energy node including communications to the appliance.
A secondary processor (labelled “2^{nd} Micro”) which is configured to manage the on/off control of the power output. This processor is configured to turn off the power output when correctly requested to do so by the main processor. In an envisaged implementation the secondary processor has sufficient autonomy and intelligence to automatically turn the power on at power-up (while the main processor is busy booting up) and to turn the power on if it loses communication with the main processor for a pre-defined period of time. The secondary processor may also have the ability to automatically reset the main processor if communications with it are lost for an extended period of time. In an envisaged arrangement the requirements of this processor are relatively simple and the embedded firmware can be written in the lowest level language to thereby enable full and extensive testing in order to improve its long-term reliability.
A three-port Ethernet switch which eliminates the need for additional network cabling or infrastructure. In an envisaged arrangement, one port of the switch connects to the existing network in place of the PC, the second port of the switch connects to the PC, and the third port of the switch is used to connect the energy node to the network.
Optionally, surge protection and EMI filtering circuitry can also be included into the energy node helping to protect the attached appliance from surges on the power supply and reducing the amount of EMI noise put back onto the mains supply by the appliance.

In an envisaged implementation the above functionality could be integrated into the power socket itself or an intelligent cable management product. It is also envisaged that the power line carrier could replace the Ethernet communications network.

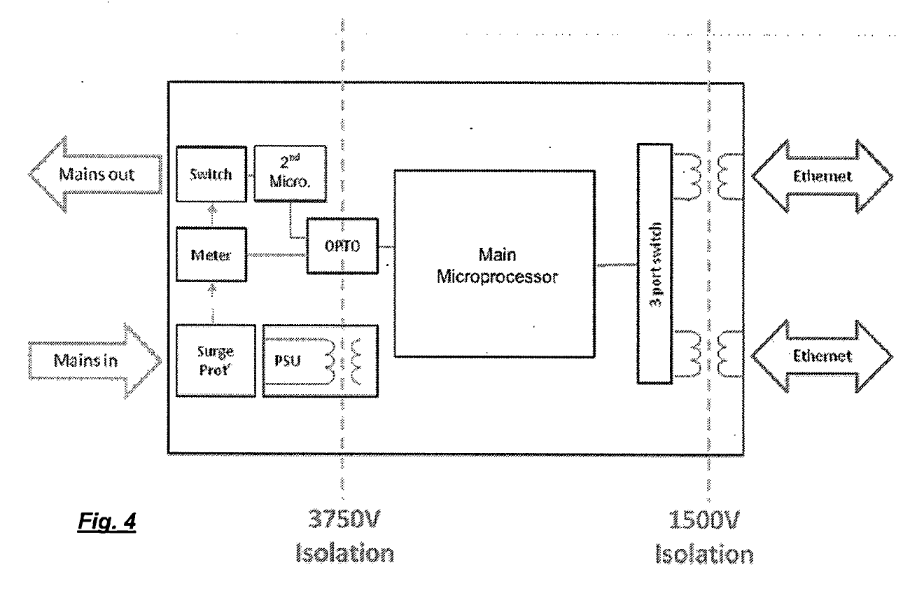

As the energy node connects to both the power infrastructure of the building and the data network, particular attention has been given to ensuring the robustness of the electrical isolation barriers (as shown in FIG. 4) within the energy node.

In one envisaged implementation the node communicates with the energy automation appliance 11 using a RESTful “web services” architecture. Under this architecture, each of the nodes acts as a web server that delivers a “service” in response to a request from the energy appliance which acts as the “client”. The RESTful element refers to the fact that the details behind the request are contained within the header of the HTTP request.

In such an arrangement the energy automation appliance 11 makes a request for information or for an update to the nodes configuration, by sending an HTTP request to a specific URI (Uniform Resource Identifier) that is served by the energy node's web server. In response the energy node returns the requested information back in either XML or JSON format.

As mentioned above, although this document place particular emphasis on the interaction between computing resources, nodes and the energy automation appliance, the teachings of the present invention are equally applicable to any energy consuming appliance within or outside of the building.

Energy Automation Appliance

In this implementation the energy automation appliance is a piece of computing hardware; in some implementations a standard PC architecture that runs dedicated software. The elements of the software include:
An operating system; for example a Linux derivative for long-term stability and reliability
A database; for example MySQL
A web server; used to display web pages which form the user interface to the system, and to deliver web services to the shutdown module, the status module and the energy automation service; and
A policy orchestrator application; which application comprises a dedicated software module that is configured to automatically run an energy management policy at the correct time and/or under the correct conditions. The policy orchestrator also carries out a number of interactions within the system to ensure that it is safe to turn off a connected appliance before doing so. The policy orchestrator is also able to send “Wake On LAN” messages to specific PCs on the network in order to wake them up from sleep or hibernation in line with a “wake up” type policy.

Shutdown Module

The shutdown module is a simple application that will automatically turn a computing resource off at a pre-determined time when other requirements are also met—such as when it is determined that that resource is not being used.

If the resource is in use at the time the shutdown is set for, the user is not interrupted by any pop-ups the software module is configured simply to wait a further pre-defined period and check again to see if the resource is still in use. The shutdown module will continue to do this until the resource is no longer in use—then it will produce a pop-up giving the user (if still present) an opportunity to delay the shutdown process.

Unusually, the shutdown software module is configured to use a web-services methodology to allow the shutdown settings to be managed centrally—by the energy automation appliance.

In this case, the computing resource is the “client” which requests an update (from the energy automation appliance—the server) to its shutdown settings every time the energy status of the computing resource changes.

The significance of this architecture is that it enables centralized management of shut-down policies while still meeting the very strict security requirements of certain commercial enterprises—which requirements dictate that a user's computer can only ever be a client on the enterprise's network. For security organisations such as banks will not allow any computer to act as a “server” on their network.

In a particularly preferred implementation the shutdown module is also configured to automatically save any unsaved documents to a secure location on the computing resource (or a network to which it is connected) before it shuts down. These documents can be easily recovered from a folder on the user's desktop.

Status Module

The status module is a small foot-print software “service” that runs on the computing resource and monitors the current energy status of the resource.

In the context of a personal computer, the status modules is configured to send a message to the energy automation appliance if the status changes between any one of the standard windows energy states, such as hibernate, resume, user log-on, etc. Similar arrangements may be devised for other types of computing resource.

Understanding this status is important to ensure that a resource is not accidentally turned off while it is still in use—as this will almost certainly result in data loss.

Again a web-services methodology is used to communicate with the appliance where the resource is the client—meeting the security requirements of certain commercial enterprises.

Policy Override Device

In an envisaged implementation the policy override device is a wired or wireless switch or other input device that is used to override a policy in a specific area. When the button is pressed or the device is triggered by another input such as an alarm relay or PIR detector, a message is sent to the appliance informing the appliance that someone has just entered a specific area and wishes to override any shutdown policies in that area

The policy override switch may be connected directly to the energy appliance or may communicate with it over the Ethernet network in order to extend the distance that the override device can be away from the energy automation appliance.

Where the override device communicates across the network a web-services methodology is used.

The policy override device can also be used in conjunction with a “protection policy” to trigger a single or series of protection events within the building. For example, if a fire alarm is triggered, the energy automation appliance could automatically turn off all appliances under its control to help limit the spread of the fire. Similarly, all PCs could be turned off in the event of a burglary—reducing the risk of data theft.

During system installation, the building is divided up into virtual “energy zones”. Each override device can be assigned to a specific zone, group of zones or even an individual user—allowing a single override device to control a single user or an entire enterprise.

Energy Automation service

The energy automation service is a web based service that allows a building owner access to his “energy automation” system remotely allowing him/her to set and change energy policies from a remote location.

The energy automation service is a set of software applications that are remotely hosted, for example in a data centre—the services are delivered to the customer through the “software as a service” model.

The service is provided by exploiting historical energy consumption data stored within the data centre. This data is collected from the energy appliances within the customers building either using a web services architecture (where allowed by the customer) or by an automatic back-up process—where each energy appliance packages and sends data to the data centre on a regular basis.

In order to provide some near real-time elements to the services, a web services model may be used. Through this model specific pieces of current information are requested from the buildings energy automation appliance by the service. In this case, the energy automation appliance acts as the server and the data centre is the client. This architecture allows the energy automation service to provide a wide range of tools and services such as reporting, billing, alerts, etc.

Key features of this implementation are as follows:
An energy node with a 2 processor architecture enhances the reliability of the energy node by removing direct control of the on/off functionality from the main processor. As a consequence, if the main processor should “crash” it can be re-booted by the secondary processor without interrupting the power supply to the attached appliance.
An energy node with an integrated 3-port Ethernet switch reduces the need for any additional Ethernet cabling or additional external switches.
The combed use of energy nodes, energy automation appliance and status module allows energy management policies to be used safely together—for example without accidentally turning off an appliance when it is still in use.
The use of computing resources as “sensors”—once the status of all PCs are known, the system can make assumptions and decisions about how to manage the appliances within the building.

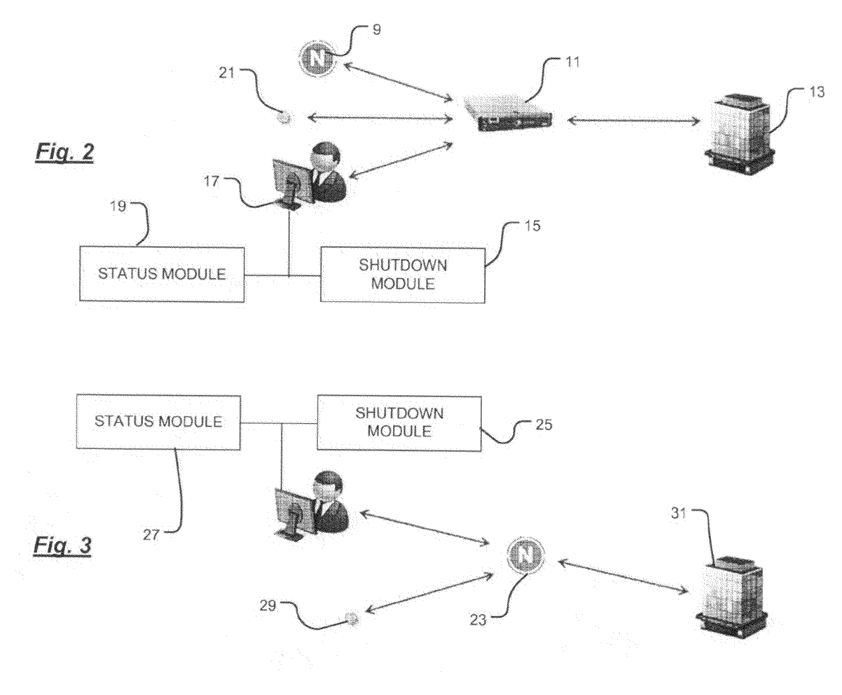

FIG. 3 is a schematic representation of another envisaged implementation of an illustrative energy management system (in this instance, a system for managing energy usage by computing resources). In this illustrative implementation the system comprises:
Distributed energy nodes 23—a small item of hardware which is designed to fit within the cable management infrastructure of a building, such as perimeter cable trunking, floor boxes, power poles, etc.—effectively placing an energy management device behind one or more power sockets within the building
A shutdown software module 25; an application which will turn a computing resource off at a particular time of day,
A status module 27; an application that communicates the current energy status of an appliance (in this instance, a computing resource) to its associated energy node 23 ensuring that the power to the appliance is not turned off while the appliance is still running (i.e. when it is in use). The current energy status of the appliance is indicative of whether or not the appliance is in use. When the appliance (in this instance, a computing resource) is not in use it may occupy a reduced energy state such as: i) a screen saver mode; ii) a hibernation mode; iii) a sleep mode; or iv) a shut down mode.
Policy override device 29; a simple input device such as a push-button located in the vicinity of a group of computing resources and other appliances being controlled by the system. The policy override device broadcasts to all with the energy nodes and allows a local energy management policy to be easily overridden—for example if an employee returns to an office out of hours.
An Energy Automation service 31; in this implementation a web based service that allows a user remote access to their “energy automation” system so that they can set and change energy policies from a remote location. The energy automation service also provides other tools such as reporting, billing, etc.

Working together, these five elements provide an energy management system that can automatically adapt to how the building is being used by its inhabitants—continuously optimising and reducing the operational energy consumption of the building as a whole.

Further details of these elements are provided in the headed sections below.

Energy Node

In an envisaged implementation (see FIG. 4) the energy node 23 is a small hardware device which can be fitted behind the power sockets of a building. The energy node consists of:
an energy meter
a device for controlling the power output—allowing a connected appliance to be turned on or off. This device could be a relay or a solid-state switch such as a TRIAC or a combination of the two—where the TRIAC is used to switch the current (handling any inrush currents) while the more efficient RELAY carries the current shortly after the switching event.
A main processor which measures and calculates analogue variables such as voltage, current, energy consumption, etc of the connected appliance(s) and communicates the measurements to the energy automation services for processing and storage. The main processor runs an embedded operating system, real-time clock, local policy orchestrator application, embedded database (for short-term local storage of energy data) and a web server and is responsible for all of the complex tasks carried out within the node including communications to the energy automation service. In this implementation there is provided a local policy orchestrator application that comprises a dedicated application which runs within the main processor of the energy node to automatically orchestrate an energy management policy at the correct time and/or under the correct conditions. The policy orchestrator also carries out a number of interactions with the appliance being managed and other elements of the system to ensure that it is safe to turn off a connected appliance before doing so. The policy orchestrator is also able to send “Wake On LAN” messages—when its attached appliance comprises a computing resource—through its direct Ethernet connection in order to wake the computing resource up from sleep or hibernation in line with a “wake up” type policy.
A secondary processor (labelled “2^{nd} Micro.”) which manages the on/off control of the power output. This process will turn off the power output when correctly requested to do so by the main processor. In a preferred arrangement, the secondary processor has sufficient autonomy and intelligence to automatically turn the power on at power-up (while the main processor is busy booting up) and to turn the power on if it looses communication with the main processor for a pre-defined period of time. The secondary processor also has the ability to automatically reset the main processor if communications with it are lost for an extended period of time. The requirements of this processor have been deliberately simplified and the embedded firmware has been written in the lowest level language so that it can be fully and extensively tested to ensure its long-term reliability.
A three-port Ethernet switch that eliminates the need for additional network cabling or infrastructure. One port of the switch connects to the existing network in place of the computing resource, the second port of the switch connects to the computing resource, and the third port of the switch is used to connect the main processor of the energy node to the network.
Optionally, surge protection and EMI filtering circuitry can also be included into the energy node helping to protect the attached appliance from surges on the power supply and reducing the amount of EMI noise put back onto the mains supply by the appliance.

Optionally the node my have a local policy override switch attached directly to the node which will directly override the node when operated. In some implementations, the above functionality could be integrated into the power socket itself or an intelligent cable management product. In addition (as before) in some implementations a power line carrier could replace the Ethernet, communications network.

As the energy node connects to both the power infrastructure of the building and the data network, particular attention has been given to ensuring the robustness of the isolation barriers within the product (as shown in FIG. 4).

Where the appliance being managed is a computing resource, it is envisaged that the energy node communicates with the Energy Automation Service using a RESTful “web services” architecture. Under this architecture, each of the nodes acts as a web server that delivers a “service” in response to a request from the computing resource or energy automation service which acts as the “client”. The RESTful element refers to the fact that the details behind the request are contained within the header of the HTTP request.

The computing resource or energy automation service makes a request for information or for an update to the nodes configuration, real-time clock settings or local energy policy by sending an HTTP request to a specific URI (Uniform Resource Identifier) that is served by the nodes web server. In response the node returns the requested information back in either XML or JSON format.

As aforementioned, although this document describes the interaction between computing resources, nodes and the energy automation service at length, this solution is equally applicable to any appliance within or outside of a building.

Shutdown Module

The shutdown module is a simple application that will automatically turn the resource off at a pre-determined time when other requirements are also met—such as when it's not being used.

If the resource is in use at the time the shutdown is set for, the user is not interrupted by any pop-ups the software will simply wait a further pre-defined period and check again to see if the resource is still in use. The application will continue to do this until the resource is no longer in use—then it will produce a pop-up giving the user (if still present) an opportunity to delay the shutdown process.

Unusually, the shutdown module uses a web-services methodology to allow the shutdown settings to be managed centrally—by the energy automation service or its local energy node.

In this case, the computing resource is the “client” which requests an update (from the energy service or node—the server) to its shutdown settings every time the energy status of the computing resource changes.

The significance of this architecture is that it enables centralized management of shut-down policies while still meeting the very strict security requirements of certain enterprises—where a users computer can only ever be a client.

The shutdown module is also configured to automatically save any unsaved documents to a secure location on the computing resource or to a connected Network before it shuts down. These documents can be easily recovered from a folder on the user desktop.

Status Module

The Status Module is a small foot-print “service” that runs on the computing resource and monitors the current energy status of the resource.

In the context of a PC, if the status changes between any one of the standard windows energy states, such as hibernate, resume, user log-on, etc; the Status Module sends a message to its connected energy node.

Understanding this status reduces the change of a computing resource being accidentally turned off while it is still in use—as this will almost certainly result in data loss.

Again a web-services methodology is used to communicate with the energy node where the resource is the client—meeting the security requirements of the certain organisations.

Policy Override Device

In this implementation the policy override device is a wired or wireless switch or other input device that is used to override a policy in a specific area. When the button is pressed or the device is triggered by another input such as an alarm relay or PIR detector, a message is broadcast across the Ethernet network to all energy nodes informing them that someone has just entered a specific area and wishes to override any shutdown policies in that area. The energy nodes are “paired” to all relevant override devices during the installation process. Each energy node is responsible for listening to each broadcast and determining whether any action is required as a result of the override device being triggered.

The policy override device can also be used in conjunction with a “protection policy” to trigger a single or series of protection events within the building. For example, if a fire alarm is triggered, the energy system could automatically turn off all appliances under its control to help limit the spread of the fire. Similarly, all appliances could be turned off in the event of a burglary—reducing the risk of data theft.

During system installation, the building is divided up into virtual “energy zones”. Each override device can be assigned to a specific zone, group of zones or even an individual user—allowing a single override device to control a single user or an entire enterprise.

Energy Automation Service

The energy automation service is a web based service that allows remote access to an “energy automation” system from a remote location, thereby allowing a user to set and change energy policies from a remote location.

The energy automation service is a set of software applications that are remotely hosted, for example in a data centre—the services are delivered to the customer through the “software as a service” model.

The service is provided by exploiting historical energy consumption data stored within the data centre. This data is collected from the energy nodes within the user's building either using a web services architecture (where allowed by the customer) or by an automatic back-up process—where each energy node packages and sends data to the data centre on a regular basis. Because of the small physical size of the node, it can only hold a relatively small amount of energy data—perhaps a month or so of data; so this back-up process is more significant in a distributed system.

In order to provide some near real-time elements to the services, a web services model is used. Through this model specific pieces of current information are requested directly from the distributed energy nodes by the service. In this case, the energy nodes act as the server and the data centre is the client.

This architecture allows the energy automation service to provide a wide range of tools and services such as reporting, billing, alerts, etc

System Interactions within a Distributed System

The widely distributed nature of the energy management system of this particular implementation, means that the system-level interactions needed to change policy settings and to view the collected data are very different to a system which has a centralized data collection and policy setting entity.

In this implementation the node itself is responsible for the collection and short-term storage of energy data and the orchestration of “local” energy management policies.

As a result, when a user or system administrator wishes to view data about the user, that data is generated and displayed by the web-server embedded into the node of the device. The user uses his/her web browser to directly access the node.

To simplify navigation between a large number of nodes within a building or enterprise an “indexing application” may be run on the customers' intranet web site or through the energy automation service.

Any “aggregated view” of data collected from multiple energy nodes would be collected and viewed in real-time from this indexing application. If the user then wishes to drill down into data at the single energy node level—the user is automatically and seamlessly switched to data that is generated and presented by the node itself.

Similarly, if the user wishes to update an energy policy, if the policy applies to multiple nodes, the user will interact with the indexing application that will pass-down the policy to all of the relevant nodes. If only one node is relevant than the user will again be directed seamlessly to the node itself. All changes to policies are made through a web based form interface.

The advantage of this approach is that the system is effective and easy to manage as a single node and scales easily to several hundred nodes.

The system of this implementation has several advantages over that previously disclosed, for example:
Lower system cost; there is no need for an “energy automation appliance”—particularly important in low node-count installations
Reduced traffic over the Ethernet network; most interactions occur between the node and it's directly connected PC as a result the amount of energy management data transmitted through the enterprise wide Ethernet network is greatly reduced
Improved system reliability; there is no centralized energy appliance to fail—providing improved reliability and better service availability

It will be appreciated that whilst various aspects and embodiments of the present invention have heretofore been described, the scope of the present invention is not limited to the particular arrangements set out herein and instead extends to encompass all arrangements, and modifications and alterations thereto, which fall within the scope of the appended claims.

For example, it is envisaged that information corresponding to the current energy status of at least one computing resource may be transferred to one or more secondary energy management systems. Current energy status information may by utilised by a secondary energy management system for the purpose of increasing the efficiency with which energy is used by that system. One example of a secondary energy management system is a building management system (BMS) configured to control the lighting and/or heating in a building.

A BMS configured to control the lights in a building may utilise information detailing which computing resources are currently not in use in that building (and where such computing resources are located). In particular a BMS may use such information to switch off or reduce the amount of lighting in the vicinity of computing resources that are not in use (on the assumption that people are not in that area and hence lighting is not required).

Similarly a BMS configured to control the heating or other services in a building may utilise computing resource status information to switch off (or reduce) heat or other services in parts of a building where computing resources that are not in use are located.

With reference to FIG. 5, the status module 19 (in the energy management system of FIG. 2) may be configured to transfer information concerning the energy status of computing resource 17 to the energy automation appliance 11 each time the energy status of the computing resource 17 changes. The energy status of a computing resource may change for example when a user logs on or off the computing resource and/or when the computing resource changes between: i) an in use state; ii) a screensaver mode; iii) a sleep mode; iv) a hibernation mode; or v) a shut down mode for example. It is envisaged that energy status information may be transferred from the energy automation appliance 11 (via the energy automation service 13 in one implementation) to a secondary energy management system 33.

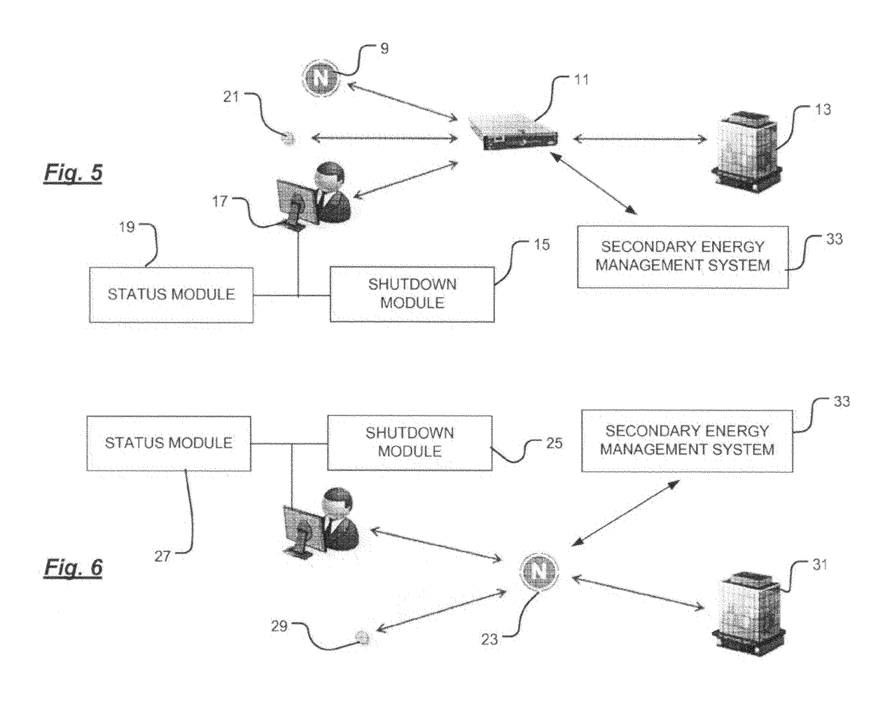

Similarly with reference to FIG. 6, it is also envisaged that the status module 27 (in the energy management system of FIG. 3) may be configured to transfer information concerning the energy status of its respective computing resource to the energy node 23 each time the energy status of the computing resource changes. Such energy status information may then be transferred from the energy node 23 (via the energy automation service 31 in one implementation) to a secondary energy management system 33.

In other envisaged implementations, the information transferred to the secondary energy management system may also be used for purposes other than energy management. For example, if the information transferred indicates that a given computing resource has not been used during business hours of a given day, then it may be inferred (and optionally recorded, for example in a personnel management system) that the person to whom that computing resource has been allocated was not at work that day. Similarly, the information transferred may be used to record a time at which a given computing resource was first switched on in the morning, and a time at which the computing resource was switched off in the evening, and from this information it may be inferred the number of hours worked by a given employee in a given day. As aforementioned, in some arrangements more than one computing resource may be coupled to a particular node. In such an arrangement a BMS may cause the amount of lighting and/or heating in the location of a node coupled to more than one computing resource to be turned off (or reduced) when all the computing resources coupled to that node are determined not to be in use.

It will further be appreciated that where certain functionality has been described above in the context of software modules, persons skilled in the art will be aware that this functionality could alternatively be implemented in hardware, or indeed in a mix of hardware and software, and hence the teachings of the present invention should not be interpreted as being limited only to a software implementation.

Lastly, it should also be noted that whilst the accompanying claims set out particular combinations of features described herein, the scope of the present invention is not limited to the particular combinations hereafter claimed, but instead extends to encompass any combination of features (from any implementation) herein disclosed.

1. An energy management system comprising:
policy establishment means for establishing one or more energy policies, the or each said policy being configured for managing the energy consumption of at least one energy consuming appliance; and
at least one energy node configured to communicate with said energy policy establishing means to implement an energy policy for the control of at least one energy consuming appliance with which said energy node is configured to communicate.

2. The system of claim 1, wherein the policy establishment means comprises a first energy automation device configured to receive instructions corresponding to said energy policy.

3. The system of claim 2, wherein the first energy automation device is configured to communicate a control signal corresponding to said instructions to at least one said energy node.

4. The system of claim 3, wherein the first energy automation device is configured to communicate said control signal to at least one said energy node via a second energy automation device.

5. The system of claim 4, wherein said at least one energy node comprises a switch controller for switching on or off an energy consuming appliance in response to said control signal.

6. (canceled)

7. The system of claim 5, wherein said energy consuming appliance is configured to transfer a signal corresponding to the energy status of said energy consuming appliance to said secondary energy automation device.

8. The system of claim 7, wherein the secondary energy automation device is configured to transfer the signal corresponding to the energy status of said energy consuming appliance to a secondary energy management system.

9. The system of claim 5, wherein said energy consuming appliance is configured to transfer a signal which corresponds to the energy status of the energy consuming appliance to said at least one energy node.

10. The system of claim 9, wherein said at least one energy node is configured to transfer the signal which corresponds to the energy status of said energy consuming appliance to a secondary energy management system.

11. The system of claim 8, wherein said secondary energy management system is a building management system.

12. The system of claim 11, wherein said building management system is configured to control the heat and/or lighting in a building.

13. The system of claim 5, wherein said at least one energy node further comprises monitoring means configured to determine the energy status of said energy consuming appliance.

14. The system of claim 13, wherein said switch controller is configured to switch off said energy consuming appliance only when a first predetermined energy status is detected by said monitoring means.

15. The system of claim 14, wherein said first predetermined energy status corresponds to a non-use energy state of said energy consuming appliance.

16. The system of claim 15, wherein said at least one energy node comprises a first processor for controlling said switch controller and a second processor for controlling said energy monitoring means.

17. The system of claim 1, further comprising policy override means which, when activated, is configured to override said energy policy.

18. (canceled)

19. The system of claim 1, wherein said energy consuming appliance is a computer.

20. (canceled)

21. An energy management system comprising:
an energy automation appliance configured to store instructions corresponding to at least one energy policy, said energy policy being configured for managing the energy consumption of at least one energy consuming appliance; and
at least one energy node configured to receive a control signal relating to said instructions from said energy automation appliance, said at least one energy node comprising: a) a switch controller for controlling a supply of energy to an energy consuming appliance and b) monitoring means for determining an energy status of said energy consuming appliance;
wherein the switch controller is configured to switch on or off said energy consuming appliance in accordance with the control signal and to only switch off said energy consuming appliance when the energy status of that appliance is determined to be in a predetermined state.

22. An energy management system comprising:
an energy automation appliance configured to receive, and transmit a control signal containing instructions relating to at least one energy policy, said energy policy being configured for managing the energy consumption of at least one energy consuming appliance; and
at least one energy node configured to receive said control signal, said at least one energy node comprising: a) a switch controller for controlling a supply of energy to an energy consuming appliance and b) monitoring means for determining an energy status of said energy consuming appliance;
wherein the switch controller is configured to switch on or off said energy consuming appliance in accordance with the control signal and to only switch off said energy consuming appliance when the energy status of that appliance is determined to be in a predetermined state.

23. A method of managing energy comprising the steps of:
providing an energy automation appliance;
receiving by the energy automation appliance instructions relating to at least one energy policy, said instructions being configured to implement an energy policy for the control of at least one energy consuming appliance;
communicating a control signal from the energy automation appliance to at least one energy node, the control signal relating to said instructions;
receiving said control signal by said at least one energy node; and
operating said at least one energy node to switch on or off an energy consuming appliance in accordance with said control signal.

24-42. (canceled)
